(19) United States
(12) Patent Application Publication
(10) Pub. No.: US 2018/0181935 A1
(43) Pub. Date: Jun. 28, 2018

(54) DENOMINATION DISTRIBUTION AND REALLOCATION SYSTEMS AND METHODS

(71) Applicant: Wal-Mart Stores, Inc., Bentonville, AR (US)

(72) Inventor: Christopher M. Johnson, Bella Vista, AR (US)

(21) Appl. No.: 15/847,550

(22) Filed: Dec. 19, 2017

Related U.S. Application Data
(60) Provisional application No. 62/438,568, filed on Dec. 23, 2016.

(51) Int. Cl. G06Q 20/20; G06F 17/30

(52) U.S. Cl. CPC G06Q 20/202; G06F 17/30227

(57) ABSTRACT

In some embodiments, systems and methods are provided that reallocate quantities of denominations. Some embodiments provide retail till check-in denomination allocation systems, comprising: a transaction history database; a reallocation rules database; and a reallocation system control circuit configured to: evaluate a check-in time of a till relative to a duration rule, and identify that a check-out duration of the till is more than a threshold duration and spanning more than a single transaction period; identify check-in quantities for each of multiple different denominations of currency at the check-in time; and access reallocation rules, and define based on the reallocation rules representative reallocation of the check-in quantities for each of the multiple different denominations across each of multiple transaction periods of time such that portions of the check-in quantities for the multiple different denominations are considered to have been available during the respective multiple transaction periods.

### CROSS-REFERENCE TO RELATED APPLICATION

This application claims the benefit of U.S. Provisional Application No. 62/438,568, filed Dec. 23, 2016, which is incorporated herein by reference in its entirety.

### TECHNICAL FIELD

This invention relates generally to tracking denominations at retail facilities.

### BACKGROUND

In a modern retail environment, there is a need to improve the customer service and convenience for customers. One aspect of customer service is enabling some customers to use cash to purchase products and/or receive cash advances. The use of cash at a retail facility simplifies purchases for some customers.

### BRIEF DESCRIPTION OF THE DRAWINGS

Disclosed herein are embodiments of systems, apparatuses and methods of tracking and reallocating quantities of different denominations of currency at retail shopping facilities. This description includes drawings, wherein:

FIG. 1 illustrates a simplified block diagram of an exemplary retail till check-in denomination allocation system, in accordance with some embodiments.

FIG. 2 illustrates a simplified flow diagram of an exemplary process of defining distribution ratios and reallocating quantities of denominations across a check-out duration that extends beyond a single transaction period, in accordance with some embodiments.

FIG. 3 illustrates a simplified graphic representation of a histogram defined by the estimated quantities of a determined distribution of check-in quantities of a denomination, in accordance with some embodiments.

FIG. 4 illustrates a simplified flow diagram of an exemplary process of allocating denominations based on a till check-in, in accordance with some embodiments.

FIG. 5 illustrates a simplified flow diagram of an exemplary process of reallocating quantities of denomination across multiple transaction periods based on a till being checked-out over more than one transaction period, in accordance with some embodiments.

FIG. 6 illustrates an exemplary system for use in implementing methods, techniques, devices, apparatuses, systems, servers, sources and enabling the reallocation of quantities of denominations, in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment of the present invention. Thus, appearances of the phrases “in one embodiment,” “in an embodiment,” “in some embodiments”, “in some implementations”, and similar language throughout this specification may, but do not necessarily, all refer to the same embodiment.

Generally speaking, pursuant to various embodiments, systems, apparatuses and methods are provided to define a reallocation of quantities of denominations of currency over multiple predefined periods of time. Some embodiments comprise a retail till check-in denomination allocation system that includes a transaction history database, a reallocation rules database, and a reallocation system. The transaction history database stores information corresponding to sales transactions at each of multiple point-of-sale (POS) systems located at one of the multiple different retail facilities. The reallocation rules database that stores rules applied in reallocating quantities of different denominations of the currency. The reallocation system comprises a reallocation control circuit configured to evaluate a check-in time of a cash till relative to a duration rule, and to identify that a check-out duration of the till, between a check-out time and the checked-in time of the till, is more than a threshold duration. In some instances, it may be identified that the check-out time spans more than a single transaction period that the till is scheduled or intended to be checked out. The reallocation control circuit can further identify check-in quantities for each of multiple different denominations of currency at the check-in time. Reallocation rules are accessed and based on at least some of the reallocation rules a representative reallocation is defined of the check-in quantities for each of the multiple different denominations across each of multiple transaction periods of time such that portions of the check-in quantities for the multiple different denominations are considered to have been available during the respective multiple transaction periods.

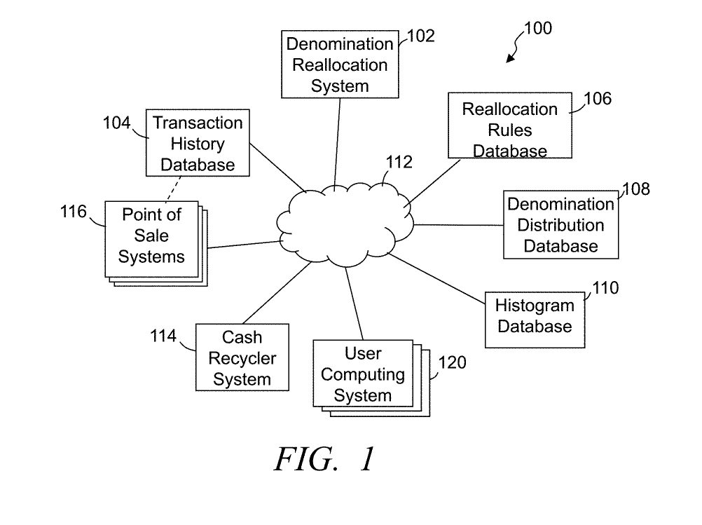

FIG. 1 illustrates a simplified block diagram of an exemplary retail till check-in denomination allocation system 100, in accordance with some embodiments. The denomination allocation system 100 comprises a reallocation system 102. Further, the denomination allocation system includes a transaction history database 104, a reallocation rules database 106, and a denomination distribution database 108. In some implementations, the denomination allocation system includes a histogram database 110. The reallocation system 102 is communicatively coupled with the databases through one or more communication and/or computer networks 112. Further, some embodiments include one or more cash recycler systems 114. One or more user computing systems 120 may further be communicatively coupled with the reallocation system 102, databases, cash recycler systems and/or other devices of the till check-in denomination allocation system 100 to allow workers to access information, reports, receive notifications and the like.

The transaction history database 104 stores and maintains information corresponding to sales transactions at each of multiple point-of-sale (POS) systems 116 located at one or more of multiple different retail facilities. Some embodiments implement a transaction history databases for each of multiple retail facilities. Other implementations implement one or more transaction history databases for a plurality of retail facilities. The transaction history databases receive transaction history information for each of the multiple POS systems. The information can include a POS system identifier where a transaction occurred, a till identifier identifying the removable till or cash box being used at the POS system during a sales transaction, timing of when the sales transaction occurred, the total cost of the sales transaction, cost of individual items purchased, taxes charged, worker identifier for a worker operating the POS system, total amount of currency (sometimes referred to below as “cash”, and includes multiple different denominations) received from a customer, total amount of cash returned as change and/or cash advance to a customer, product identifier information of products purchased, other such information, or combination of two or more of such information. In some embodiments, the transaction history database comprises a series of interrelated cells into which information is stored, with different cells associated with a single sales transaction being linked. This linking enhances the speed of access to content to be used by the reallocation system 102.

The reallocation rules database 106 maintains particular and unconventional rules that are utilized and applied by the reallocation system 102 in determining and defining the reallocation of quantities of denominations of currency over multiple transaction periods. The denominations can be bills, coins or the like. The reallocation system 102 accesses the reallocation rules in determining how quantities of denominations are to be allocated between multiple transaction periods during which a till was checked out. In some instances, a transaction period is a defined limited period of time that a till is scheduled or intended to be checked out. For example, in some implementations, a transaction period of time is less than or equal to a 24 hour period (e.g., tills checked out during a day should be checked back in by midnight that day). Some embodiments apply a margin of time following a transaction period or before a subsequent transaction period to allow one or more tills to be checked out for a subsequent transaction period, and/or some time beyond the specified check-in limit (e.g., till may be checked in by 2:00 am and still be considered by the reallocation system as checked in within the threshold check-in time and/or within a transaction period).

The denomination distribution database 108 maintains datasets and/or other information regarding the quantities and/or distribution of different denominations for transaction periods. As a till is checked-in, the quantities of the denominations can be stored in the denomination distribution database 108 to be used by one or more other systems and/or as information for one or more processes. For example, quantities of denomination can be used in subsequently forecasting the needs of one or more shopping facilities' quantities of the different denominations.

In some retail facilities, tills are checked out for an intended transaction period of time. The check-out in some implementations may be provided through one or more cash recycler systems 114 at a retail facilities. The cash recycler system maintains quantities of currency to be distributed amongst multiple tills, maintained for reserves, and in some instances to collect some quantities to be deposited with a bank or other financial institution. A cash recycler system may additionally receive tills and/or the quantities of denominations in a till at check-in. Further, the cash recycler system may be configured to receive “cash drops” from one or more different tills during a transaction period (e.g., a till receives a threshold number of a denomination, and the worker removes a cash drop quantity of the denomination and returns it to the cash recycler system, or places the cash drop quantity into a safe or other storage and causes a notification to be provided to the cash recycler system identifying the till and the quantity of the denomination). This cash dropping can be performed for any denomination of the multiple denominations. The cash recycler or other system can record the cash drop and update records to associate the cash drop with the till, the worker, and/or other associations. Similarly, the cash recycler system may provide additional quantities of one or more denominations when a till has less than a threshold quantity. The cash recycler system can issue the additional quantity of the denomination and associate that additionally quantity to the till, the worker and/or other associations.

In some embodiments, the cash recycler system may be configured to count the quantities, maintain records regarding quantities and/or communicate quantities information to the transaction history database, a recycler database, and/or other database to maintain records regarding quantities of denominations. Further, in some implementations, the cash recycler system maintains information about when tills are checked out and checked in (e.g., based on a unique till identifier, worker identifier that checked out the till, and/or other such relevant information), changes in quantities of denominations of a till between check-out and check-in, other such information, and typically a combination of two or more of such information. In some embodiments, the denomination quantities or counts, check-out and check-in timing information, and other such information can be accessed by the reallocation system 102 to be processed relative to at least the reallocation rules in identifying when a till is checked in and whether a till has been checked out for more than a threshold time and/or a transaction period, quantities of denominations, and other such processing.

In some embodiments, the reallocation system 102 evaluates a check-in time of a till relative to one or more duration rules defined within the rules database. The duration rules, at least in part, defines a transaction period based on a threshold check-in time, a threshold duration and/or other such parameters. For example, one or more duration rules include identifying for a till a check-out date and time, and comparing that check-out date and time to a transaction period during the time of the check out to determine whether the till was checked out beyond the transaction period. As introduced above, the transaction period may terminate at a predefined time (e.g., 12:00 AM). When a till is not checked in by the termination time (or within a threshold period of the termination time) the till can be designated as a multi-transaction period till. Similarly, one or more rules may determine whether a till is checked out for more than a threshold time based on the check-out date and time and the check-in date and time. Some embodiments in applying one or more rules identify that a check-out duration of the till, between a check-out time and the checked-in time, is more than a threshold duration and spans more than a single transaction period. For example, a till may have been checked out at 7:00 PM on a Monday, and checked back in at 3:00 PM on the next day, where a transaction period terminates at 12:00 AM. Accordingly, the till is checked out spanning two transaction periods (i.e., a portion of the Monday transaction period, and a portion of the Tuesday transaction period). Further, some embodiments may disregard a till, with regards to denomination reallocation, that is checked out for less than the threshold period of time. For example, tills that are checked out for a relatively short duration (e.g., 5 minutes, 10 minutes, 30 minutes, or some other relevant threshold duration), the reallocation system may disregard this till in determining whether and/or how to reallocate quantities of denomination.

The reallocation system 102 further identifies check-in quantities for each of multiple different denominations of currency at the check-in time. These check-in quantities includes the total quantities of each denomination, which is being considered with regard to reallocation, at the time of check-in, and typically further includes any quantities of denominations that were removed from the till for a cash drop to a safe, a cash recycler system, or the like, quantity transferred to another till, or otherwise removal of quantities of one or more denominations. Again, quantities of denominations within a till may exceed a cash drop threshold and workers will cash drop a drop quantity to the local safe, cash recycler system or the like. Based on the reallocation rules, the one or more cash drop quantities are typically considered as part of the quantities of denominations received through the till and are subject to being defined as allocated over the time the till was checked out. A total quantity of each denomination to be considered for reallocation at the check-in time is determined, which includes the quantities in the till at check-in and the cash dropped quantities.

In some embodiments, the reallocation system further accesses the reallocation rules and defines based on one or more of the reallocation rules a representative reallocation of the check-in quantities for each of the multiple different denominations across each of multiple transaction periods of time such that portions of the check-in quantities for the multiple different denominations are considered to have been available during the respective multiple transaction periods. Some embodiments, in reallocating the number of denominations define or determine a quantity or distribution ratio or proportional quantity of the corresponding denomination for the different transaction periods of the check-out duration (i.e., time the till was checked out), and/or a relative proportional quantity of a denomination received for each sales transaction occurring through the till and over the check-out duration.

In some instances, the reallocation system accesses a distribution ratio rule or rules, and applies the distribution ratio rule in determining distribution ratios for each of the multiple transaction periods. The distribution ratio, in some embodiments, is determined as a function of the number of a particular denomination determined to have been received during a single sales transaction, and a determined total number of the denomination to have been received through the till over the check-out duration. The distribution ratio may additionally be determined as a function of a check-in quantity of the denomination (i.e., the quantity within the till, plus one or more quantities of one or more cash drops if performed during the check-out duration, and in some instances other quantities that may have been removed for other reasons (e.g., transferred to another till, or other such movement of quantities of the denomination)). In some embodiments, for example, a distribution ratio per transaction is determined according to:

$$\frac{( \# of denominations for one transaction )}{( Total \# received over check \text{-} out duration )} * ( Total \# checked in ) ,$$

where “# of denomination for one transaction” is the quantity of the denomination estimated to have been received in a single sales transaction; “Total # received over check-out duration” is the total number of the denomination estimated to have been received over the check-out duration; and “Total # checked in” is the total number of the denomination checked in at the check-in time (which typically includes quantities of the denomination that were cash dropped during the check-out duration, and other movements of quantities of the denomination (e.g., transfer to another till)).

Additionally or alternatively, some embodiments determine the distribution ratios as a function of the portions of a transaction period a till was checked out. For example, when a transaction period is a 24 hour period (e.g., extends from 12:00 AM to 12:00 AM), and a till is checked out at 8:00 PM on a Tuesday, and checked back in at 7:00 AM on Thursday, the till check-out duration extends across three transaction periods (i.e., the Tuesday from 8:00 PM-12:00 AM; the Wednesday from 12:00 AM to 12:00 AM; and the Thursday from 12:00 AM to 7:00 AM), with the distribution ratios being proportional, at least in part, on the different durations of the different transaction periods the till was checked out. When such proportional durations are considered, the distribution ratios may be dependent on the multiple transaction periods as a function of a duration of each of the multiple transaction periods relative to the check-out duration (e.g., 4/35, 24/35, and 7/35). The reallocation system, in defining a reallocation of the check-in quantities of the denominations can, in some embodiments, determine the portions of the check-in quantities of the multiple different denominations based on the distribution ratios for each of the different denomination over the multiple transaction periods.

Some embodiments apply one or more denomination distribution rules in defining estimated receive times of items (e.g., bills, coins, etc.) of the checked in quantities of the multiple different denominations. The reallocation system can access one or more denomination distribution rules, and apply, for each of the multiple transaction periods of the check-out duration and for each of the multiple different denominations, at least one of the denomination distribution rules to determine and define estimated receive times of each item of the checked in quantities of the multiple different denominations. The estimated receive times are typically distributed over the corresponding one of the multiple transaction periods of the checked-out duration. This estimated receive times can take into consideration different sales transactions that occur during the multiple transaction periods, and allocate different portions of one or more items of one or more denominations relative to each of the different sales transactions. Some embodiments apply a set of quantity estimation rules for each denomination rule relative to total cost per sales transaction. For example, the rules may identify each sales transaction having a total cost of greater than $100 dollars when attempting to identify sales transactions where a $100 bill is received at the till. In some implementations, for example, the reallocation system may identify, when applying one or more rules, each sales transaction having a total cost of greater than a first transaction threshold, and for each whole number multiple of a first denomination under consideration estimate an item of the first denomination is received (e.g., for each sales transaction having a total cost greater than the first threshold, the reallocation system estimates that a $100 dollar bill is received for each whole number multiple of $100 dollars).

Further, one or more rules may identify each sales transaction having a total cost that is less than the first transaction threshold or a portion of the total cost that is less than a whole number multiple of the first transaction threshold while greater than a whole number multiple of a second transaction threshold. For each whole number multiple of the second transaction threshold the reallocation system can estimate an item of a second denomination is received (e.g., for each sales transaction having a total cost or a portion of a cost less than $100 dollars and greater than a whole number multiple of $20 dollars, the reallocation system estimates that a $20 dollar bill is received). One or more rules may be applied to identify each sales transaction having a total cost that is less than the second transaction threshold or a portion of the total cost that is less than a whole number multiple of the second transaction threshold while greater than a whole number multiple of a third transaction threshold. For each whole number multiple of the third transaction threshold the reallocation system can estimate an item of a third denomination is received (e.g., for each sales transaction having a total cost or a portion of a cost less than $20 dollars and greater than a whole number multiple of $5 dollars, the reallocation system estimates that a $5 dollar bill is received).

One or more additional rules may be applied to identify each sales transaction having a total cost that is less than the third transaction threshold or a portion of the total cost that is less than a whole number multiple of the third transaction threshold while greater than a whole number multiple of a fourth transaction threshold. For each whole number multiple of the fourth transaction threshold the reallocation system can estimate an item of a fourth denomination is received (e.g., for each sales transaction having a total cost or a portion of a cost less than $5 dollars and greater than a whole number multiple of $1 dollar, the reallocation system estimates that a $1 dollar bill is received). As a specific example, if a sales transaction is identified having a total cost of $278.00 dollars, where a first transaction threshold is $100 dollars, a second transaction threshold is $20 dollars, a third transaction threshold is $10 dollars, a fourth transaction threshold is $5 dollars, and a fifth transaction threshold is $1 dollar; the sales reallocation system may estimate for this sales transaction that: two (2) $100 dollar bills were received; three (3) $20 dollar bills were received; one (1) $10 bill was received; one (1) $5 dollar bills was received; and three (3) $1 dollar bills were received. These rules can be applied relative to any number of translation thresholds relative to any number of different denominations. Similarly, some embodiments may disregard one or more denominations. For example, the reallocation system may not attempt to reallocate $10 dollar bills.

Some embodiments utilize the determined quantity of denominations per sales transaction and generate one or more histograms for a respective one of the denominations. The reallocation system may define a separate denomination histograms for each of the multiple different denominations that is representative of a percentage spread over time of when the items of the checked-in quantities of respective denominations of the multiple different denominations are received at the till. The reallocation system, applies the denomination histograms as at least part of one or more denomination rules in defining the estimated receive times and/or distribution of estimated received items of the respective denominations.

In some embodiments, the reallocation system can evaluate the sales transactions associated with a till for each of the multiple transaction periods. The quantities of each of the denominations received at the till can be defined for each of the sales transactions as a function of a total sales transaction price. Again, the quantities of each denomination, in some embodiments, are determined based on the distribution ratio rules. In some embodiments, the reallocation system accesses and applies one or more distribution ratio rules to determine distribution ratios for each of the multiple transaction periods as a function of an estimated number of each denomination received in each of the sales transactions relative to an estimated total number of the corresponding denomination received over the check-out duration. In defining the reallocation of the check-in quantities, the reallocation system can determine the portions of the check-in quantities of the multiple different denominations based on the distribution ratios for each of the multiple transaction periods.

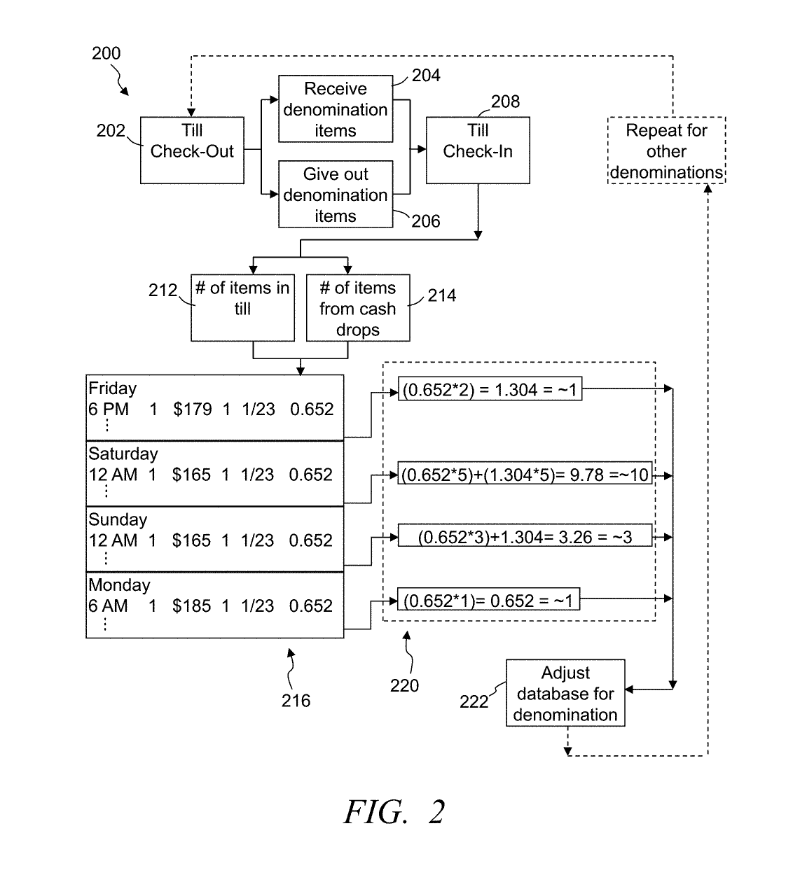

FIG. 2 illustrates a simplified flow diagram of an exemplary process 200 of defining distribution ratios and reallocating quantities of denominations across a check-out duration that extends beyond a single transaction period, in accordance with some embodiments. Table 1 below corresponds to the exemplary process 200 and illustrates an exemplary representation of timings of sales transaction over the check-out duration, which in this example extends from a check-out time of 2:00 PM on a Friday and extends to a check-in time of 7 AM on a following Monday. In this example, a transaction period is 24 hours from 12:00 AM to 12:00 AM. It will be appreciated that this is an example transaction period, and other transaction periods of more or less time may be utilized. Further, as described above, the transaction period is a predefined period of time that a till is intended to be checked out. Further, the example from FIG. 2 and Table 1 focuses on the reallocation of $100 bills. The process can be repeated for each denomination that is to be evaluated and reallocated over the check-out time.

TABLE 1
Exemplary Sales Transactions at a Till during a Check-Out Duration

| Time | Tns Qty | Tns Amnt | Item Qty | % Item Qty | Ratio |
|---|---|---|---|---|---|
| Friday | | | | | |
| 2 pm | Check-out | | | | |
| 5 pm | 1 | $179 | 1 | 1/23 | 0.652 |
| 8 pm | 1 | $151 | 1 | 1/23 | 0.652 |
| 11 pm | | | | | |
| Saturday | | | | | |
| 12 am | 1 | $165 | 1 | 1/23 | 0.652 |
| 4 am | 1 | $167 | 1 | 1/23 | 0.652 |
| 7 am | 1 | $185 | 1 | 1/23 | 0.652 |
| 9 am | 1 | $202 | 2 | 2/23 | 1.304 |
| 12 pm | 1 | $210 | 2 | 2/23 | 1.304 |
| 2 pm | 1 | $245 | 2 | 2/23 | 1.304 |
| 4 pm | 1 | $235 | 2 | 2/23 | 1.304 |
| 5 pm | 1 | $178 | 1 | 1/23 | 0.652 |
| 8 pm | 1 | $153 | 1 | 1/23 | 0.652 |
| 9 pm | 1 | $245 | 2 | 2/23 | 1.304 |
| 11 pm | | | | | |
| Sunday | | | | | |
| 12 am | 1 | $165 | 1 | 1/23 | 0.652 |
| 6 am | 1 | $185 | 1 | 1/23 | 0.652 |
| 2 pm | 1 | $255 | 2 | 2/23 | 1.304 |
| 8 pm | 1 | $163 | 1 | 1/23 | 0.652 |
| 11 pm | | | | | |
| Monday | | | | | |
| 12 am | | | | | |
| 6 am | 1 | $185 | 1 | 1/23 | 0.652 |
| 7 am | Check-in | | | | |

As described above, a cash recycler system 114 can check-out a till at step 202. While the till is checked-out, one or more workers/POS systems perform purchase transactions where cash is received in step 204, and cash is returned to customers in step 206 as change, cash advances and/or other such cash outputs. The cash recycler system checks-in the till at step 208 closing the check-out duration. Again, the cash recycler system or other system records the check-out and check-in times. The reallocation system 102 uses the check-out and check-in times to determine whether the check-out duration extends beyond a single transaction period (e.g., in this example beyond 12:00 AM). As indicated in Table 2, the check-out duration extends beyond a single transaction period (from a Friday evening through a Monday morning), and includes at least parts of four different transaction periods (e.g., part of Friday, Saturday, Sunday, and part of Monday).

The reallocation system further accesses information regarding the check-in and/or check-out quantities of each denomination of currency that is to be considered for reallocation. This can include step 212 to identify the quantity of a denomination in the till at check-in (e.g., five $100 bills in the till at check-in), and step 214 to identify the quantities if any of the denomination from one or more cash drops (e.g., ten $100 bills, resulting in this example of a total of 15 $100 bills attributed to the till at check-in (five in the till at check-in and ten cash dropped)).

Still referring to Table 1 and FIG. 2, the reallocation system further accesses sales transaction data from the transaction history database 104 over the check-out duration corresponding to the till being evaluated. The sales transactions are evaluated in step 216 relative to at least one and typically multiple transaction thresholds. For example, the sales transactions associated with the till can be evaluated to identify sales transactions that exceed a first transaction threshold, in this example of greater than $150. In the illustrated example of Table 1, there is identified 23 sales transactions that have a total sales transaction price greater than $150 during the check-out duration. The reallocation system in applying one or more reallocation rules determines a quantity of $100 bills for each of the 23 sales transactions based, in this example, on the whole number multiples of $100 dollars.

Table 1 illustrates an example of the 23 sales transactions, with the table identifying times during which the transaction occurred (in this example, by hour; however, other periods can be used); the number or quantity of transactions (“Tns Qty”) within the corresponding hour that had a total sales price of greater than the first transaction threshold (e.g., $150); a total transaction sales price (“Tns Amnt”); the number of items of the denomination (“Item Qty”), which in this example are $100 bills; a percentage of the received items of the denomination (“% Item Qty”) determined based on the number of items of the denomination in this transaction relative to the total number of transactions meeting the one or more transaction thresholds under consideration for the denomination being evaluated (in this example, number of sales transactions having a transaction price greater than $150 dollars); and a determined distribution ratio (“Ratio”) for each sales transaction. In some embodiments, the distribution ratio for a transaction is defined by the quantity of items of a denomination predicted to have been received in the sales transaction, divided by the estimated total quantity of items of the denomination received over the check-out duration, times the quantity of the denomination associated with the till at check-in (e.g., in this example, for the first transaction in the 5 AM hour on the Friday, there is a single $100 bill (quantity of items=1), with the total of 23 transactions meeting the first transaction threshold, and the total of 15 $100 bills associated with the checked-in till, providing the determined distribution ratio of ( 1/23)*15=0.652 quantities of the denomination (i.e., 0.652 of a single $100 bill)).

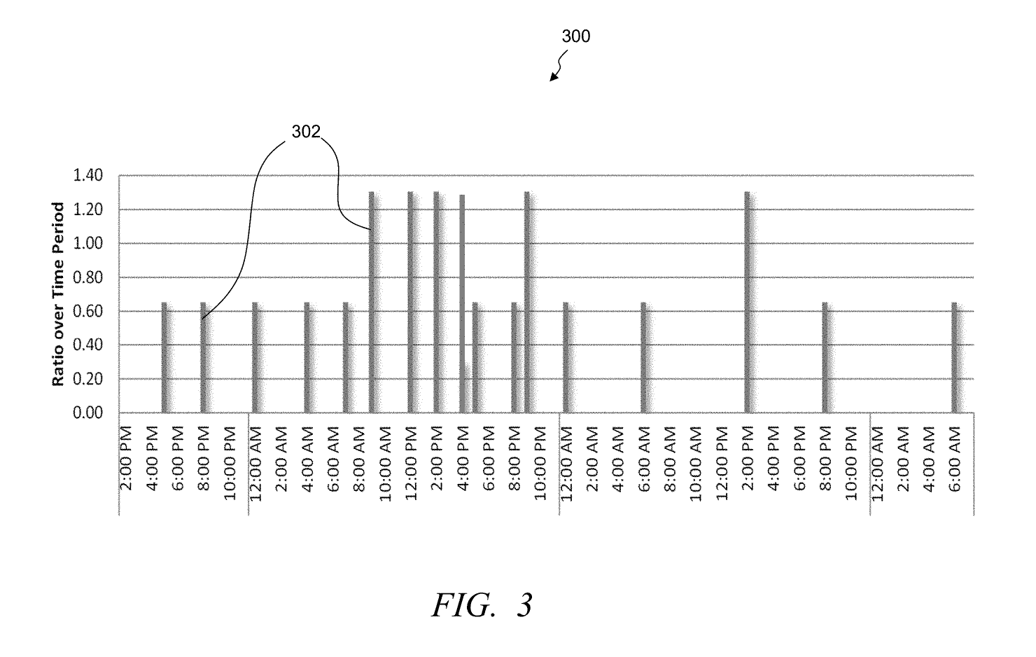

FIG. 3 illustrates a simplified graphic representation of a histogram 300 defined by the estimated quantities of the determined distribution of the check-in quantities of the $100 denominations in the example of FIG. 2 and Table 1, in accordance with some embodiments. The histogram illustrates the determined quantities or portions of quantities of denominations 302 received relative to time. The generated histogram can be maintained in the histogram database 110.

Still referring to FIGS. 2-3 and Table 1, based on the determined quantities and portions of quantities of denominations allocated over the times corresponding to transactions that comply with the distribution rules and multiple transaction thresholds, the total quantities per transaction period can be determined in step 220 by summing the quantities and portions of quantities of denominations allocated to the respective transaction periods of the check-out duration. In the example of FIGS. 2-3 and Table 1, the transaction period is 24 hours, or portion of the 24 hours during which the till is checked-out (that is the till, in this example, should be checked-in by 12:00 AM). As such, the check-out duration spans four transaction periods (i.e., 2:00 PM-12:00 AM, Friday; 12:00 AM-12:00 AM Saturday; 12:00 AM-12:00 AM Sunday; and 12:00 AM-7:00 AM Monday). In this example, the summation of the determined distribution of the received $100 bills is:

| | | |
|---|---|---|
| Friday | (0.652 * 2) = 1.304 | = ~1 |
| Saturday | (0.652 * 5) + (1.304 * 5) = 9.78 | = ~10 |
| Sunday | (0.652 * 3) + 1.304 = 3.26 | = ~2 |
| Monday | (0.652 * 1) = 0.652 | = ~1 |
| Total | | 15 bills |

The reallocation system 102 uses the determined distribution of the quantity of the denomination allocated to each transaction period to define the estimated quantity of the denomination that would have expected to be checked-in had the till been checked-in within or at least at the end of each of the multiple transaction periods spanned by the checked-out duration. In step 222, the determined estimated distribution of the denominations over the different transaction periods can be used to update the denomination distribution database 108 to incorporate and/or add these quantities to the database. The process 200 can be repeated any number of times for any number of additional denominations. For example, the process 200 can be repeated to define estimated reallocations of $20 dollar bills, $5 dollar bills, and $1 dollar bills, over the transaction durations over which the check-out duration extends. Having the estimated quantities of the different denominations over the different transaction periods allows, for example, for a more accurate forecasting of needs of the different denominations. In some implementations, the reallocation system 102 merges the estimated representative reallocation of the denomination of the multiple transaction periods of time with additional datasets of unmodified received quantities of the denomination from other tills checked-in during the multiple transaction periods.

In repeating the process 200 for other denominations of currency, the process considers those sales transactions that have sales totals that are greater than the denomination, including those sales transactions identified in allocating larger denominations. For example, in Table 1, there is an exemplary sales transaction for a total of $179 during the 5:00 PM hour. Based on the transaction thresholds, the reallocation system may reallocate the total as (1) one $100 bill, and the $79 remainder is further processed based on other transaction thresholds to estimate that three $20 dollar bills were received, one $10 dollar bill, one $5 dollar bill, and four $1 dollar bills. Similarly, for a sales transaction that has a total of $23, the process can estimate that the sale included one $20 dollar bill, and three $1 dollar bills; a sales transaction that has a total of $9 can be estimated to have included one $5 dollar bill and four $1 dollar bills; and other such estimations for other sales transactions. In some embodiments, the reallocation system 102 evaluates each of the sales transactions through the till being evaluated and during the check-out duration in estimating denominations received, and using those estimates in relation to the total number of the denominations at check-in to reallocate and distribute the denominations over the multiple transaction durations. It is noted that some embodiments may not reallocate one or more denominations. For example, the reallocation system 102 may disregard the reallocation of small coin denominations, one or more bills that are less used (e.g., $10 dollar bills), or other denominations.

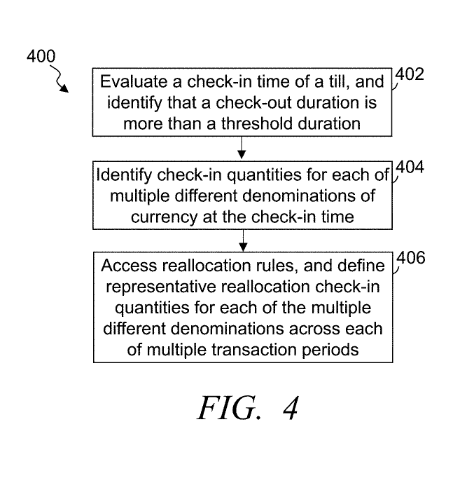

FIG. 4 illustrates a simplified flow diagram of an exemplary process 400 of allocating denominations based on a till check-in, in accordance with some embodiments. In step 402, a check-in time of a till is evaluated relative to a duration rule. In some instances, this evaluation leads to identifying that a check-out duration of the till, between a check-out time and the checked-in time of the till, is more than a threshold duration and spans more than a single transaction period. Again, because the till is checked-out over multiple transaction periods the allocation of quantities of multiple denominations for each transaction period is unknown. This missing information can have adverse effects on one or more processes that use the datasets and/or other information regarding the quantities and/or distribution of different denominations for transaction periods.

In step 404, check-in quantities are identified for each of multiple different denominations of currency at the check-in time. The check-in quantities includes the number of denominations in the till as well as cash drops. In some instances other quantities may be considered as part of the check-in quantities. For example, in some instances, transferred quantities to another till or the like may be counted. In step 406, reallocation rules are accessed and based on the reallocation rules a representative reallocation check-in quantities are defined for each of the multiple different denominations across each of multiple transaction periods of time such that portions of the check-in quantities for the multiple different denominations are considered to have been available during the respective multiple transaction periods.

In accessing the reallocation rules, the reallocation system can access one or more distribution ratio rules, and apply the distribution ratio rules to determine distribution ratios for each of the multiple transaction periods as a function of an estimated number of each denomination received in sales transactions relative to an estimated total number of the corresponding denomination received over the check-out duration. In some embodiments, the portions of the check-in quantities of the multiple different denominations are determined based on the distribution ratios for each of the different denomination over the multiple transaction periods.

Some embodiments access the denomination distribution rules and apply, for each of the multiple transaction periods of the check-out duration and for each of the multiple different denominations, at least one of the denomination distribution rules, and define estimated receive times of each item of the checked-in quantities of the multiple different denominations distributed over the corresponding one of the multiple transaction periods. Separate denomination histograms for each of the multiple different denominations can be generated and/or accessed that are representative of a percentage spread over time of when the items of the checked-in quantities of the respective one of the multiple different denominations are received at the till. The denomination histograms can be applied as at least part of a denomination rule in defining the estimated receive times. In some embodiments, the sales transactions associated with the till are evaluated for each of the multiple transaction periods, and quantities of each of the denominations received at the till can be defined, for each of the sales transactions, as a function of a total sales transaction price.

In some embodiments, one or more distribution ratio rules are accessed and applied to determine distribution ratios for each of multiple transaction periods as a function of an estimated number of each denomination received in sales transactions relative to an estimated total number of the corresponding denomination received over the check-out duration. The reallocation system in defining the reallocation of the check-in quantities can determine the portions of the check-in quantities of the multiple different denominations based on the distribution ratios for each of the multiple transaction periods. Further, the reallocation system typically merges the representative reallocation check-in quantities of the multiple denominations over the multiple transaction periods of time with datasets of unmodified received quantities of denominations from other tills checked-in during the multiple transaction periods.

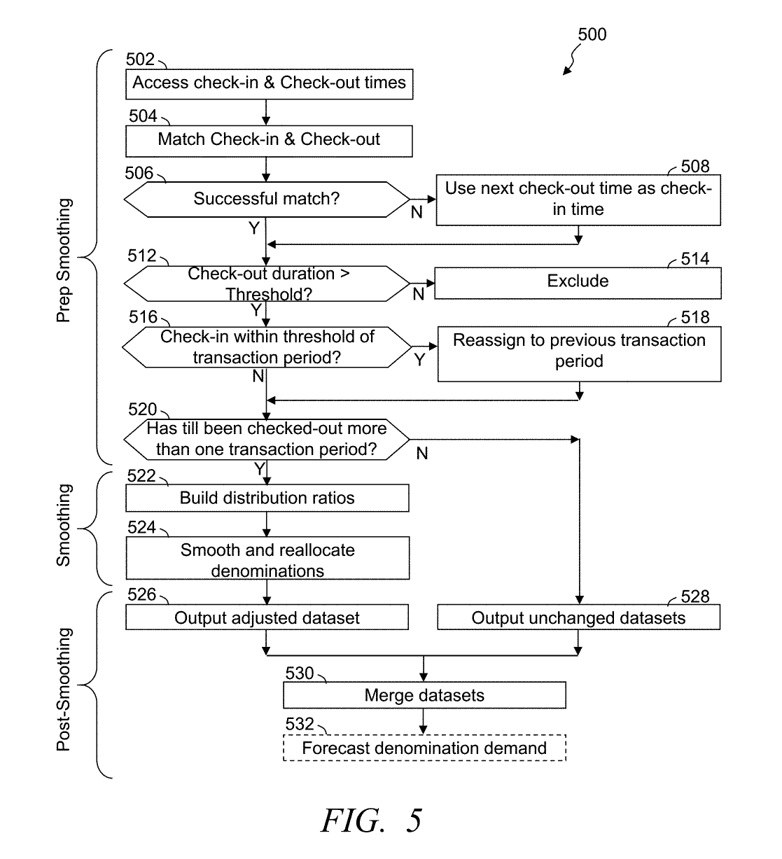

FIG. 5 illustrates a simplified flow diagram of an exemplary process 500 of reallocating quantities of denomination across multiple transaction periods based on a till being checked-out over more than one transaction period, in accordance with some embodiments. In step 502, check-in and check-out times of a till is obtained from a database, a cash recycler system, stored in the reallocation system 102, or the like. Typically, a till includes a unique identifier and/or is supplied a unique identifier at check-out. This allows the system to associate check-out and check-in times with a specific till. In step 504, the system matches a check-out time of the till with a checked-in time, when a checked-in time is available.

In step 506, it is determined whether a checked-in time has been successfully matched with a checked-out time. The process advances to step 508 when a match is not identified and a checked-in time is defined as the subsequent requested check-out time. As such, the reallocation system identifies that the till may have incorrectly been checked back in or was not checked back in before being reused and/or recycled. In step 512, it is determined whether the checked-out duration (e.g., period of time between the check-out time and the checked-in time) is greater than one or more checked-out threshold periods. In some instances, the till may be checked out so long that accurate reallocation cannot be determined, the data is too stale to be effectively utilized in subsequent evaluations and/or decisions, and/or other reasoning. Accordingly, in some embodiments, when the checked-out duration is greater than the checked-out threshold (e.g., greater than 10 days, 20 days, 30 days, some other threshold) the till is excluded from the denomination distribution database 108, datasets and/or other such information.

When the checked-out duration is less than the threshold, the process 500 continues to step 516 to determine whether the check-in time is within a transaction period or within a threshold time of an end of a transaction period. For example, a transaction period may end at 3:00 AM, and a check-in threshold of two or three hours may be defined. When the check-in time is within the transaction period, the check-in is associated with the transaction period in which the till was checked-in. Further, when the check-in time is within the check-in threshold (e.g., before 5:00 AM when the transaction period ends at 3:00 AM and the check-in threshold is two hours), the process continues to step 518 to designate the till check-in as occurring in the previous transaction period even though the till was actually checked in the following transaction period.

In step 520, the reallocation system determines whether the till has been checked-out for a period of time that extends across two or more transaction periods. When the check-out duration spans two or more transaction period the reallocation system 102, in step 522, applies one or more of the reallocation rules to build distribution ratios for the multiple transaction periods and each of the different denominations being considered. Further, the distribution ratios, in some embodiments, are determined as a function of a quantity of items of a denomination for each different sales transactions occurring with the multiple transaction periods and the total items of the denominations received during the multiple transaction periods.

In step 524, the reallocation system 102 smooths and reallocates the checked-in quantities of the different denominations over the multiple transaction periods that are part of the checked-out duration. In some instances, the smoothing includes the allocation based on sales transactions during sub-periods of time of the transaction period (e.g., per hour, per half-hour, or the like). In some embodiments, the reallocation includes determining, based on the ratios and in some instances histogram distributions, the portions of one or more items of each denomination associated with the sales transactions within a sub-period estimated to have been received through the till, and the estimated allocation of those portions of the items of the denominations to the respective transaction periods. The estimated allocations of items of the denominations (e.g., based on rounding up or down as appropriate) is accumulated in one or more datasets and outputted in step 526.

In some embodiments, the outputted allocations are stored in the denomination distribution database 108. Similarly, in step 528, those datasets of unmodified check-in quantities of denominations of other tills that were checked-in during the one or more transaction periods and only corresponding to a single transaction period. Accordingly, those unmodified check-in quantities are associated with the single transaction period and reallocation is not needed. In step 530, the reallocated datasets and unmodified datasets are merged into a single dataset and/or the denomination distribution database 108. The merged denomination distribution database can subsequently be used in step 532 in one or more other processes, such as forecasting denomination quantities needed by the shopping facility, forecasting deposit amounts of one or more denominations, evaluating historic denomination usage, and/or other such processes. In some instances, steps 502 through 520 can correspond to a preparation for smoothing process, while steps 522 and 524 are part of a smoothing processes. Steps 526 through 532 may be considered part of a post-smoothing process.

In some embodiments, the reallocation system provides compensation when tills are checked-out over multiple transaction periods. As described above, when tills are checked out over multiple transaction periods it makes it difficult to identify when items of denominations were actually acquired. This can affect subsequent processing of this information, such as forecasting of denomination needs. Some embodiments may forecast and/or control quantities of denomination needs in accordance with U.S. Provisional Patent Application No. 62/317,221, filed Apr. 1, 2016, which is incorporated in its entirety herein by reference. Further, without the smoothing, data cleansing and/or denomination quantity reallocation, spikes in quantities are seen following the check-in of these tills, which can affect the accuracy of subsequent processing (e.g., forecasting).

A cash recycler system 114, in some embodiments, can check-out and check-in tills and electronically record the check-out and check-in times and dates, which can be accessed by the reallocation system 102. The reallocation system can reallocate the acquired items of the multiple denominations by estimating the contributions of items that are acquired during operation and use of the till. Some embodiments pull the check-in and check-out timing information, based on one or more till identifiers (e.g., till serial number), retail facility identifiers, and the like, as part of a denormalizing. In some instances, a till may be identified that has check-out times and no check-in times. The reallocation system can sets a check-in time as the next time the till was checked out. The checked-in till can then be evaluated and quantities of denominations reallocated across the multiple transaction periods when the till is checked-out over multiple transaction periods. Again, in some embodiments, the reallocation system identifies when tills are checked-in after the termination of the transaction period and/or beyond a threshold period after the transaction period. Of those tills checked-in, the reallocation system can further filter out some tills, such as those checked out less than a threshold period (e.g., less than 5, 10, 20 minutes, where it is unlikely the till was actually put to use), tills that were checked in within a single transaction period, and the like. Of those that were checked out over multiple transaction periods, the reallocation system can then perform the smoothing and normalization by reallocating quantities of the different denominations across the multiple transaction periods. In some embodiments, the smoothing includes the identification of quantities of denominations received for different transactions. Histograms can be generated for one or more transaction periods, and/or one or more denominations. Distribution ratios can be used, in some embodiments, to determine portions of the checked-in quantities to allocate for different sales transactions over the checked-out duration. The distributed portions of the quantities can then be used to determine quantities of denominations that should have been checked-in at each transaction period. In some embodiments, these quantities are used to update one or more databased storing information regarding quantities of denominations. These quantities can then be used in subsequent processes, such as forecasting, distribution, deposits, and/or other such processes.

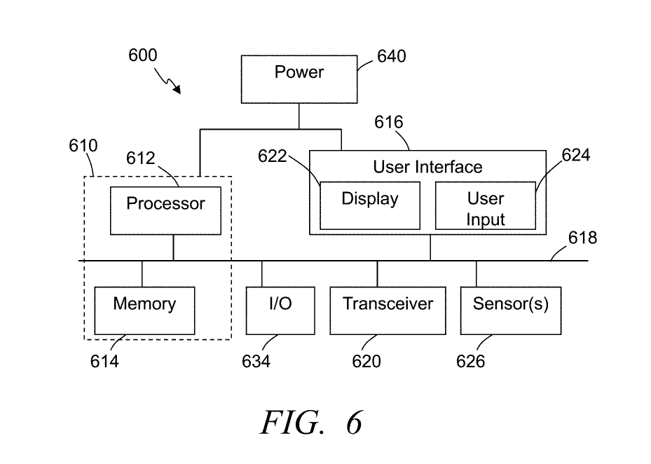

Further, the circuits, circuitry, systems, devices, processes, methods, techniques, functionality, services, servers, sources and the like described herein may be utilized, implemented and/or run on many different types of devices and/or systems. FIG. 6 illustrates an exemplary system 600 that may be used for implementing any of the components, circuits, circuitry, systems, functionality, apparatuses, processes, or devices of the denomination allocation system 100, and/or other above or below mentioned systems or devices, or parts of such circuits, circuitry, functionality, systems, apparatuses, processes, or devices. For example, the system 600 may be used to implement some or all of the denomination reallocation system 102, point of sale systems 116, cash recycler system 114, user computing systems 120, databases, and/or other such components, circuitry, functionality and/or devices. However, the use of the system 600 or any portion thereof is certainly not required.

By way of example, the system 600 may comprise a control circuit or processor module 612, memory 614, and one or more communication links, paths, buses or the like 618. Some embodiments may include one or more user interfaces 616, and/or one or more internal and/or external power sources or supplies 640. The control circuit 612 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the control circuit 612 can be part of control circuitry and/or a control system 610, which may be implemented through one or more processors with access to one or more memory 614 that can store instructions, code and the like that is implemented by the control circuit and/or processors to implement intended functionality. In some applications, the control circuit and/or memory may be distributed over a communications network (e.g., LAN, WAN, Internet) providing distributed and/or redundant processing and functionality. Again, the system 600 may be used to implement one or more of the above or below, or parts of, components, circuits, systems, processes and the like. For example, the system may implement the denomination reallocation system 102 with the control circuit being a reallocation system control circuit, a cash recycler system 114 with a recycler control circuit, a point of sale system with a POS control circuit, or other components.

The user interface 616 can allow a user to interact with the system 600 and receive information through the system. In some instances, the user interface 616 includes a display 622 and/or one or more user inputs 624, such as buttons, touch screen, track ball, keyboard, mouse, etc., which can be part of or wired or wirelessly coupled with the system 600. Typically, the system 600 further includes one or more communication interfaces, ports, transceivers 620 and the like allowing the system 600 to communicate over a communication bus, a distributed computer and/or communication network 112 (e.g., a local area network (LAN), the Internet, wide area network (WAN), etc.), communication link 618, other networks or communication channels with other devices and/or other such communications or combination of two or more of such communication methods. Further the transceiver 620 can be configured for wired, wireless, optical, fiber optical cable, satellite, or other such communication configurations or combinations of two or more of such communications. Some embodiments include one or more input/output (I/O) ports 634 that allow one or more devices to couple with the system 600. The I/O ports can be substantially any relevant port or combinations of ports, such as but not limited to USB, Ethernet, or other such ports. The I/O interface 634 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

The system 600 comprises an example of a control and/or processor-based system with the control circuit 612. Again, the control circuit 612 can be implemented through one or more processors, controllers, central processing units, logic, software and the like. Further, in some implementations the control circuit 612 may provide multiprocessor functionality.

The memory 614, which can be accessed by the control circuit 612, typically includes one or more processor readable and/or computer readable media accessed by at least the control circuit 612, and can include volatile and/or nonvolatile media, such as RAM, ROM, EEPROM, flash memory and/or other memory technology. Further, the memory 614 is shown as internal to the control system 610; however, the memory 614 can be internal, external or a combination of internal and external memory. Similarly, some or all of the memory 614 can be internal, external or a combination of internal and external memory of the control circuit 612. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over the computer network 112. The memory 614 can store code, software, executables, scripts, data, content, lists, programming, programs, log or history data, user information, customer information, product information, and the like. While FIG. 6 illustrates the various components being coupled together via a bus, it is understood that the various components may actually be coupled to the control circuit and/or one or more other components directly.

In some embodiments, systems and methods are provided to reallocate check-in quantities of different denominations. Some embodiments provide retail till check-in denomination allocation systems, comprising: a transaction history database configured to store information corresponding to sales transactions at each of multiple point-of-sale (POS) systems located at one of the multiple different retail facilities; a reallocation rules database storing rules applied in reallocating quantities of different denominations; and a reallocation system control circuit communicatively coupled with the transaction history database and the reallocation rules database, and memory storing code that when implemented by the reallocation system control circuit causes the reallocation control circuit to: evaluate a check-in time of a first till relative to a duration rule, and identify that a check-out duration of the first till, between a check-out time and the checked-in time of the first till, is more than a threshold duration and spanning more than a single transaction period; identify check-in quantities for each of multiple different denominations of currency at the check-in time; and access reallocation rules, and define based on the reallocation rules representative reallocation of the check-in quantities for each of the multiple different denominations across each of multiple transaction periods of time such that portions of the check-in quantities for the multiple different denominations are considered to have been available during the respective multiple transaction periods.

Further, some embodiments provide methods of allocating denominations based on a till check-in, comprising: by a reallocation system control circuit: evaluating a check-in time of a first till relative to a duration rule, and identifying that a check-out duration of the first till, between a check-out time and the checked-in time of the first till, is more than a threshold duration and spanning more than a single transaction period; identifying check-in quantities for each of multiple different denominations of currency at the check-in time; and accessing reallocation rules, and defining based on the reallocation rules representative reallocation check-in quantities for each of the multiple different denominations across each of multiple transaction periods of time such that portions of the check-in quantities for the multiple different denominations are considered to have been available during the respective multiple transaction periods.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A retail till check-in denomination allocation system, comprising:
a transaction history database configured to store information corresponding to sales transactions at each of multiple point-of-sale (POS) systems located at one of the multiple different retail facilities;
a reallocation rules database storing rules applied in reallocating quantities of different denominations; and
a reallocation system control circuit communicatively coupled with the transaction history database and the reallocation rules database, and memory storing code that when implemented by the reallocation system control circuit causes the reallocation control circuit to:
evaluate a check-in time of a first till relative to a duration rule, and identify that a check-out duration of the first till, between a check-out time and the check-in time of the first till, is more than a threshold duration and spanning more than a single transaction period;
identify check-in quantities for each of multiple different denominations of currency at the check-in time; and
access reallocation rules, and define based on the reallocation rules representative reallocation of the check-in quantities for each of the multiple different denominations across each of multiple transaction periods of time such that portions of the check-in quantities for the multiple different denominations are considered to have been available during the respective multiple transaction periods.

2. The system of claim 1, wherein the reallocation control circuit in accessing the reallocation rules accesses at least one distribution ratio rule and applies the distribution ratio rule in determining distribution ratios for each of the multiple transaction periods as a function of an estimated number of each denomination received in sales transactions relative to an estimated total number of the corresponding denomination received over the check-out duration.

3. The system of claim 2, wherein the reallocation control circuit in defining the reallocation of the check-in quantities determines the portions of the check-in quantities of the multiple different denominations based on the distribution ratios for each of the different denomination over the multiple transaction periods.

4. The system of claim 1, wherein the reallocation control circuit is configured to access denomination distribution rules and for each of the multiple transaction periods of the check-out duration and for each of the multiple different denominations apply at least one of the denomination distribution rules and define estimated receive times of each item of the check-in quantities of the multiple different denominations distributed over the corresponding one of the multiple transaction periods.

5. The system of claim 4, wherein the reallocation control circuit is configured to define a separate denomination histogram for each of the multiple different denominations that is representative of a percentage spread over time of when the items of the check-in quantities of the respective one of the multiple different denominations are received at the first till, and apply as at least part of one of the denomination distribution rules the denomination histograms in defining the estimated receive times.

6. The system of claim 4, wherein the reallocation control circuit, for each of the multiple transaction periods, is configured to evaluate the sales transactions associated with the first till and for each of the sales transactions define quantities of each of the denominations received at the first till as a function of a total sales transaction price.

7. The system of claim 4, wherein the reallocation control circuit is configured to:
access and apply one or more distribution ratio rules to determine distribution ratios for each of the multiple transaction periods as a function of an estimated number of each denomination received in sales transactions relative to an estimated total number of the corresponding denomination received over the check-out duration; and
in defining the reallocation of the check-in quantities determines the portions of the check-in quantities of the multiple different denominations based on the distribution ratios for each of the multiple transaction periods.

8. The system of claim 1, wherein the reallocation control circuit is configured to merge the representative reallocation check-in quantities of the multiple denominations over the multiple transaction periods of time with datasets of unmodified received quantities of denominations from other tills checked-in during the multiple transaction periods.

9. A method of allocating denominations based on a till check-in, comprising:
by a reallocation system control circuit:
evaluating a check-in time of a first till relative to a duration rule, and identifying that a check-out duration of the first till, between a check-out time and the check-in time of the first till, is more than a threshold duration and spanning more than a single transaction period;
identifying check-in quantities for each of multiple different denominations of currency at the check-in time; and
accessing reallocation rules, and defining based on the reallocation rules representative reallocation check-in quantities for each of the multiple different denominations across each of multiple transaction periods of time such that portions of the check-in quantities for the multiple different denominations are considered to have been available during the respective multiple transaction periods.

10. The method of claim 9, wherein the accessing the reallocation rules comprises accessing a distribution ratio rule and applying the distribution ratio rule in determining distribution ratios for each of the multiple transaction periods as a function of an estimated number of each denomination received in sales transactions relative to an estimated total number of the corresponding denomination received over the check-out duration.

11. The method of claim 10, wherein the defining the reallocation of the check-in quantities comprises determining the portions of the check-in quantities of the multiple different denominations based on the distribution ratios for each of the different denomination over the multiple transaction periods.

12. The method of claim 9, further comprising:
accessing denomination distribution rules; and
applying, for each of the multiple transaction periods of the check-out duration and for each of the multiple different denominations, at least one of the denomination distribution rules and defining estimated receive times of each item of the check-in quantities of the multiple different denominations distributed over the corresponding one of the multiple transaction periods.

13. The method of claim 12, further comprising:
accessing a separate denomination histogram for each of the multiple different denominations that is representative of a percentage spread over time of when the items of the check-in quantities of the respective one of the multiple different denominations are received at the first till; and
applying as at least part of one of the denomination distribution rules the denomination histograms in defining the estimated receive times.

14. The method of claim 12, further comprising:
evaluating, for each of the multiple transaction periods, the sales transactions associated with the first till; and
defining, for each of the sales transactions, quantities of each of the denominations received at the first till as a function of a total sales transaction price.

15. The method of claim 12, further comprising:
accessing and applying one or more distribution ratio rules to determine distribution ratios for each of the multiple transaction periods as a function of an estimated number of each denomination received in sales transactions relative to an estimated total number of the corresponding denomination received over the check-out duration; and
the defining the reallocation of the check-in quantities comprises determining the portions of the check-in quantities of the multiple different denominations based on the distribution ratios for each of the multiple transaction periods.

16. The method of claim 9, further comprising:
merging the representative reallocation check-in quantities of the multiple denominations over the multiple transaction periods of time with datasets of unmodified received quantities of denominations from other tills checked-in during the multiple transaction periods.
